(19) United States
(12) Patent Application Publication
(10) Pub. No.: US 2019/0183038 A1
(43) Pub. Date: Jun. 20, 2019

(54) SYSTEM FOR CONTROLLING PRODUCT TREATMENT FLOW THROUGH DISTRIBUTION LINES

(71) Applicant: CNH Industrial Canada, Ltd., Saskatoon (CA)

(72) Inventor: Trevor Kowalchuk, Saskatoon (CA)

(73) Assignee: CNH Industrial Canada, Ltd.

(21) Appl. No.: 15/843,157

(22) Filed: Dec. 15, 2017

(51) Int. Cl. A01C 23/00; G05D 11/13

(52) U.S. Cl. CPC A01C 23/007; G05D 11/133; A01C 23/008

(57) ABSTRACT

A treatment system includes multiple treatment lines configured to flow treatment chemicals from a treatment chemical supply to multiple distribution lines that transport agricultural product to row units of an implement. The treatment system also includes at least one a pump fluidly coupled to the multiple treatment lines. In addition, the at least one pump drives the treatment chemicals to flow from the treatment chemical supply to the multiple distribution lines through the multiple treatment lines. Moreover, the treatment system includes multiple valves, wherein each of the multiple valves is fluidly coupled to at least one of the multiple treatment lines. Further, each of the multiple valves controls the flow of the treatment chemicals through the at least one of the multiple treatment lines.

### BACKGROUND

The present disclosure relates generally to a system for controlling product treatment flow through distribution lines.

Generally, seeding implements are towed behind a tractor or other work vehicle and deliver agricultural products (e.g., seed, fertilizer, other particulate material, etc.) to a field. Seeding implements may also be coupled to a product storage tank configured to store the agricultural products and/or treatment chemicals for the agricultural products. Further, the agricultural products and treatment chemicals may be stored separately and combined in lines from the product storage tank to the seeding implement. For example, primary lines may flow the agricultural products to the seeding implement, and treatment lines may flow treatment chemicals to the primary lines. Present primary lines do not enable different flow rates of treatment chemicals through different primary lines.

### BRIEF DESCRIPTION

In one embodiment, a treatment system includes multiple treatment lines configured to flow treatment chemicals from a treatment chemical supply to multiple distribution lines that transport agricultural product to row units of an implement. The treatment system also includes at least one a pump fluidly coupled to the multiple treatment lines. In addition, at least one pump drives the treatment chemicals to flow from the treatment chemical supply to the multiple distribution lines through the multiple treatment lines. Moreover, the treatment system includes multiple valves, wherein each of the multiple valves is fluidly coupled to at least one of the multiple treatment lines. Further, each of the multiple valves controls the flow of the treatment chemicals through the at least one of the multiple treatment lines.

In another embodiment, a treatment system includes multiple treatment lines that flow treatment chemicals from a treatment chemical supply to multiple distribution lines that transport agricultural product to row units of an implement. In addition, the treatment system includes multiple pumps, and each of the multiple pumps is fluidly coupled to at least one of the multiple treatment lines. Further, each of the multiple pumps drives the treatment chemicals from the treatment chemical supply to at least one respective distribution line of the multiple distribution lines through at least one of the multiple treatment lines. Moreover, the treatment system includes multiple motors, and each motor drives a respective pump of the multiple pumps. The treatment system also include a controller communicatively coupled to the multiple motors, and the controller is configured to independently control the multiple motors to control the flow of the treatment chemicals through the multiple treatment lines.

In another embodiment, a treatment system includes multiple treatment lines that flow treatment chemicals from a treatment chemical supply to multiple distribution lines that transport agricultural product to row units of an implement. In addition, the treatment system includes multiple pumps, and each of the multiple pumps is fluidly coupled to at least one of the multiple treatment lines. Further, each of the multiple pumps drives the treatment chemicals from the treatment chemical supply to at least one respective distribution line of the multiple distribution lines through the at least one of the multiple treatment lines. In addition, the treatment system includes multiple clutches, and each of the multiple clutches is coupled to a respective pump of the multiple pumps, and each of the multiple clutches is configured to control an output of the respective pump.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural implement coupled to an air cart having a metering system;

FIG. 2 is a schematic diagram of an embodiment of the agricultural implement and the air cart of FIG. 1;

FIG. 3 is a schematic diagram of an embodiment of a treatment system 25 that may be utilized with the air cart of FIG. 2;

FIG. 4 is a schematic diagram of an embodiment of a treatment system 25 that may be utilized with the air cart of FIG. 2;

FIG. 5 is a schematic diagram of an embodiment of a treatment system 25 that may be utilized with the air cart of FIG. 2; and

FIG. 6 is a schematic diagram of an embodiment of a treatment system 25 that may be utilized with the air cart of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Embodiments disclosed herein relate generally to a system for controlling flow of agricultural product treatment (e.g., pesticides, fertilizers, growth agents, etc.) through distribution lines. In particular, certain disclosed embodiments include an air cart coupled to an agricultural implement (e.g., a seeding implement). The air cart includes one or more product storage tanks. The air cart also includes a metering system configured to meter (e.g., regulate the flow of) agricultural product from the corresponding product storage tank(s) into product distribution lines (e.g., primary distribution lines, each of which may be fluidly coupled to one or more secondary distribution lines). The product distribution lines are configured to distribute the agricultural product to corresponding row units of the agricultural implement. The row units may include various ground engaging tools having outlets for depositing the agricultural product into soil as the agricultural implement travels through a field.

Furthermore, a treatment system may include valves and/or pumps configured to control a flow of treatment chemicals to the product distribution lines. The treatment chemicals may be utilized to discourage growth of certain organisms (e.g., fungi, insects, etc.), to enhance seed health (e.g. innoculants or growth treatments), or to enhance fertilizer uptake efficiency, and encourage the growth of the crop. Accordingly, the disclosed embodiments enable fine control of product application rates and facilitate precise application of agricultural product at the desired product application rates. For example, the disclosed embodiments may enable the treatment chemical flow to each primary line to be controlled such that each primary line receives a target quantity of treatment chemicals. Additionally, the disclosed embodiments may reduce undesirable product overlap and/or inadequate product deposition in certain portions of the field, which may in turn reduce product waste and lead to improved overall yield.

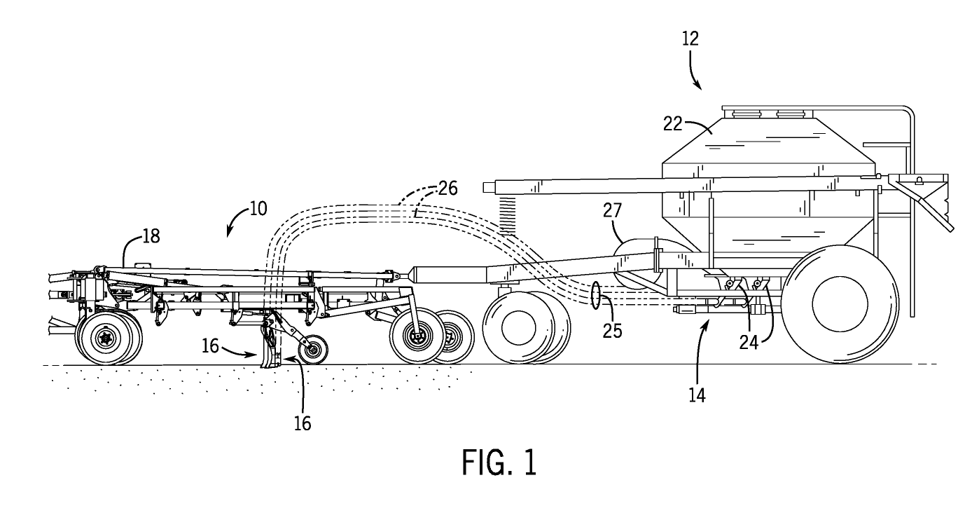

With the foregoing in mind, FIG. 1 is a side view of an embodiment of an agricultural implement 10 (e.g., a seeding implement) coupled to an air cart 12 having a metering system 14. The implement 10 includes multiple row units 16 supported by a frame 18. Each row unit 16 is configured to receive agricultural product (e.g., seed, fertilizer, other particulate material, etc.) from the metering system 14 of the air cart 12 and to deposit the agricultural product into the soil as the implement 10 travels across a field. As shown, the air cart 12 is coupled to the implement 10 via the frame 18. The air cart 12 includes a product storage tank 22 configured to store one or more agricultural products. Some embodiments may include multiple product storage tanks, such as 2, 3, 4, 5, 6, or more. Each product storage tank 22 is fluidly coupled to one or more primary product distribution lines 26 (e.g., primary lines), and each primary product distribution line 26 is configured to distribute agricultural product to one or more corresponding row units 16 of the implement 10. An air source 27 is configured to provide an air flow to each of the primary lines 26. The metered agricultural product from the metering system 14 is entrained within the air flow and pneumatically transferred to the respective row unit(s) 16 of the implement 10. Thus, the product flows from the product storage tank 22 to the metering system 14, and into the primary lines 26, with the air source 27 providing the force driving the flow of product.

Further, the air cart 12 includes a treatment system 25 configured to provide a flow of treatment chemicals to the product in the primary lines 26. For example, some agricultural products may be combined with treatment chemicals to enhance the yield. In some embodiments, the agricultural product is mixed with the treatment chemicals in the product storage tank 22 and/or before entering the product storage tank 22. In the present embodiment, the treatment chemicals is stored in a portion of the product storage tank 22 that is separate from the agricultural product. The treatment chemicals are delivered into the primary lines 26 via a pump of the treatment system 25 to combine the agricultural product in the primary lines 26 with the treatment chemicals. Combining the agricultural product and the treatment chemicals in the primary lines 26, rather than in the product storage tank 22, may reduce time spent cleaning the product storage tank 22 because the mixture of agricultural product and treatment chemicals often sticks to the walls of the product storage tank 22. Moreover, the product in the storage tank 22 is not treated with chemicals and therefore eliminates the potential waste of treating too much seed. Further, by not having treated seed in the storage tank 22, there is reduced risk of cross contaminating different products with different chemical treatments.

In some embodiments, any suitable number of meter modules 24 and/or two primary lines 26 may be utilized, such as 4, 6, 8, 9, 10, 12, or more meter modules 24 and/or primary lines 26 may be included. Additionally, while two row units 16 are shown for clarity, it should be appreciated that, in certain embodiments the implement 10 may include at least 4, 6, 8, 9, 10, 20, 30, 40, 50, 60, 70, 80, 90, 96, or more row units 16. Furthermore, each primary line 26 may provide the agricultural product to any suitable number (e.g., 1, 2, 3, 4, 5, 6, 7, 8, 9, 10, or more) of row units 16 and/or any suitable number of outlets configured to deposit product into the field (e.g., via a header and secondary lines extending between the header and respective row units). Similarly, while one product storage tank 22 is illustrated, it should be appreciated that, in certain embodiments the air cart 12 may include at least 2, 3, 4, 5, 6, or more product storage tanks 22. In FIG. 1, the air cart 12 is coupled to the implement 10, and towed behind the implement 10. In some embodiments, the air cart 12 may be towed directly behind a tow vehicle, with the implement 10 towed behind the air cart 12. Likewise, the implement 10 and the air cart 12 may be part of a single unit.

The treatment system 25 is configured to control the flow of treatment chemicals to each primary line 26. For example, the treatment system 25 may block the treatment chemicals from flowing to a certain portion of the primary lines 26 (e.g., primary line that are not receiving product from the metering system). As such, the treatment system 25 may include valve(s), pump(s), motor(s), or a combination thereof. Some embodiments may include a single motor, a single pump, and multiple valves, each valve corresponding to a respective primary line 26. Some embodiments may include a motor and a pump for each primary line 26. Some embodiments may include a pump, a motor, and a clutch for each primary line 26.

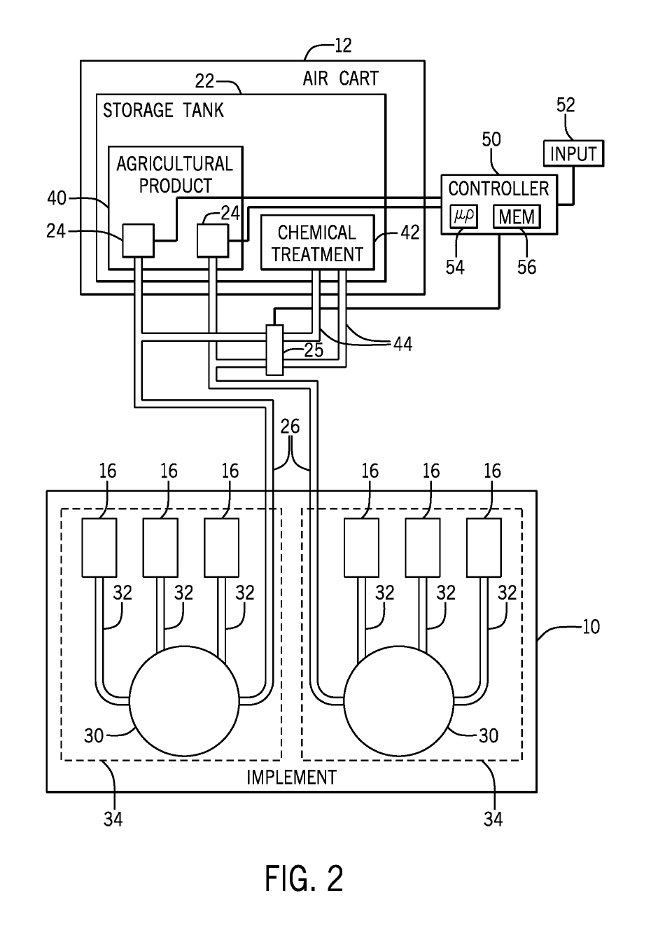

FIG. 2 is a schematic diagram of an embodiment of the implement 10 and the air cart 12. The product storage tank 22 has an agricultural product supply 40 and a treatment chemical supply 42. However, in some embodiments, the air cart 12 may include any suitable number of storage tanks 22, and the agricultural product supply 40 and the treatment chemical supply 42 may be in separate product storage tanks 22. Further, each storage tank 22 may include any suitable number of agricultural product supplies 40 and/or treatment chemical supplies 42, including 1, 2, 3, 4, 5, 6, or more. In the illustrated embodiment, each meter module 24 is configured to meter the agricultural product from the agricultural product supply 40 into a corresponding primary line 26. Further, the treatment system 25 directs treatment chemicals from the treatment chemical supply 42, through primary treatment lines 44, and into corresponding primary lines 26. Additionally, each primary line 26 is configured to direct the agricultural product to a distribution header 30 of the implement 10, and the distribution header 30 is configured to distribute the agricultural product into corresponding secondary lines 32 extending to corresponding row unit(s) 16.

Each metering module 24 and corresponding primary line 26 may provide agricultural product to separate sections 34 (e.g., a first section and a second section) of the implement 10. Each metering module 24 may be separately controlled. Accordingly, the row units 16 of one section 34 may apply the agricultural product at a different rate than the row units 16 of another section 34. Thus, the agricultural product may be applied at different rates across a width of the implement 10, and the application rate provided by each section 34 may be adjusted independently as the implement 10 travels across the field. Further, the treatment system 25 may control the flow of treatment chemicals to each primary line 26. Accordingly, the flow rate of treatment chemicals may be set to a target flow rate for the flow rate of product to each section.

A controller 50 is also included that may be located on the air cart 12, for example. The controller 50 is configured to control each meter module 24 to adjust a metering rate (e.g., meter roller turn rate), and the controller 50 is configured to control the treatment system 25 to control flow of the treatment chemicals to the primary lines 26. In certain embodiments, the controller 50 is an electronic controller having electrical circuitry configured to process signals (e.g., signals indicative of a prescription map, prescribed application rates, map or rate input, position, speed, product delay, width and/or geometry of respective geographic regions of the field) from an input 52 (e.g., spatial locating device, etc.) and/or from other components of the metering system. In some embodiments, the input 52 may be a controller having a processor and a memory, and the controller may be configured to determine a list of primary lines to receive treatment chemicals and to provide the list to the controller 50. In some such cases, the controller 50 may utilize target application rates, ground speed information, width and/or geometry of respective regions of the field, meter calibration information, or a combination thereof, to determine a target flow rate of the treatment chemicals to each primary line 26. In some embodiments, the controller 50 may control the flow rate of treatment chemicals to each primary line based at least in part on the flow rate of product through the primary line (e.g., as determined based on a target meter roller rotation rate). For example, the controller may instruct the treatment system 25 to terminate treatment chemical flow to each primary line that is not receiving product.

In the illustrated embodiment, the controller 50 includes a processor 54, such as a microprocessor, and a memory device 56. The controller 50 may also include one or more storage devices and/or other suitable components. The processor 54 may be used to execute software, such as software for controlling the metering modules 24 and/or the treatment system 25. Moreover, the processor 54 may include multiple microprocessors, one or more “general-purpose” microprocessors, one or more special-purpose microprocessors, and/or one or more application specific integrated circuits (ASICS), or some combination thereof. For example, the processor 54 may include one or more reduced instruction set (RISC) or complex instruction set (CISC) processors.

The memory device 56 may include a volatile memory, such as random access memory (RAM), and/or a nonvolatile memory, such as read-only memory (ROM). The memory device 56 may store a variety of information and may be used for various purposes. For example, the memory device 56 may store processor-executable instructions (e.g., firmware or software) for the processor 54 to execute, such as instructions for controlling the metering modules 24 and/or the treatment system 25. The storage device(s) (e.g., nonvolatile storage) may include ROM, flash memory, a hard drive, or any other suitable optical, magnetic, or solid-state storage medium, or a combination thereof. The storage device(s) may store data (e.g., a prescription rate map, location data, implement speed data, or the like), instructions (e.g., software or firmware for controlling the metering modules 24 and/or the treatment system 25), and any other suitable data. The processor 54 and/or memory device 56, or an additional processor and/or memory device, may be located in any suitable portion of the system. For example, a memory device storing instructions (e.g., software or firmware for controlling the metering modules 24 and/or the treatment system 25) may be located in or associated with each metering module 24 and/or the treatment system 25.

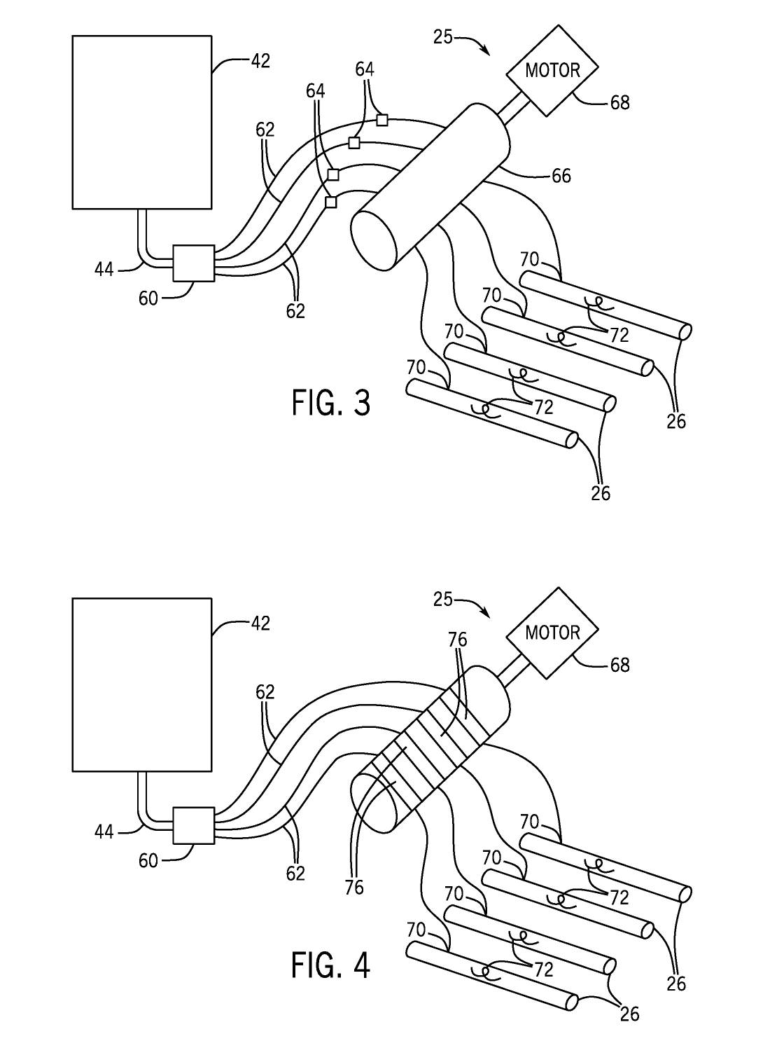

FIG. 3 is a schematic diagram of an embodiment of a treatment system 25 that may be utilized with the air cart of FIG. 2. The treatment system 25 is configured to direct treatment chemicals from the treatment chemical supply 42 to the primary lines 26. In the present embodiment, the treatment system 25 includes a splitter 60, secondary treatment lines 62, valves 64, and a pump 66 driven by a motor 68. The motor 68 drives the pump 66, which in turn drives the treatment chemicals to flow from the treatment chemical supply 42 to the primary lines 26. As the treatment chemicals travel toward the primary lines 26, the treatment chemicals pass through the primary treatment line 44, then through the splitter 60 and into the secondary treatment lines 62. Some embodiments may not include the splitter 60. In such embodiments, single lines extend from the treatment chemical supply 42 to the pump 66. In the present embodiment, the number of secondary treatment lines 62 corresponds to the number of primary lines 26. In other embodiments, each secondary treatment line may be fluidly coupled to more than one primary line. For example, one secondary treatment line may be fluidly coupled to 2, 3, 4, 5, or more primary lines. In other embodiments, each primary line may be fluidly coupled to more than one secondary treatment line. For example, one primary line may be fluidly coupled to 2, 3, 4, 5, or more secondary treatment lines.

Valves 64 are disposed along each of the secondary treatment lines 62 to control the flow of treatment chemicals through the secondary treatment lines 62. In some embodiments, at least one valve may be fluidly coupled to more than one secondary treatment line, such as 2, 3, 4, 5, or more secondary treatment lines. The valve 64 controls the flow rate through all of the secondary treatment lines 62 fluidly coupled to the valve 64. Further, the valves 64 may include any suitable type of valve, such as a cut off valve, a diverter valve, a needle valve, etc. Each valve 64 may be individually controlled (e.g., hydraulically, electrically, or manually) to control the flow of treatment chemicals through the corresponding secondary treatment line 62. For example, the controller 50 may control the valves 64, or each valve 64 may include a corresponding controller. The controller 50 may control the valves 64 based at least in part on the product flow through respective primary lines, the rate of the meter roller, etc. Further, the controller 50 may control the valve 64 to variably control the flow rate to any percentage between fully open and fully closed. In the present embodiment, the valves 64 are disposed upstream of the pump 66. In some embodiments, the valves may be disposed downstream of the pump.

After the treatment chemicals flow through the valves 64, the treatment chemicals flow through the pump 66. In the present embodiment, the pump 66 is a single pump driven by a single motor 68, and the pump 66 is fluidly coupled to all of the secondary treatment lines 62. In some embodiments, multiple motors may drive the pump, such as 2, 3, 4, or more motors. Further, some embodiments may include multiple pumps. For example, each secondary treatment line may pass through multiple pumps. In some embodiments, multiple pumps may be utilized such that only a portion (e.g., 1, 2, 3, 4, or more) of the secondary treatment lines pass through each pump. Further, the pump may be any suitable type of pump, such as a peristaltic pump, gear pump, diaphragm pump, etc. Further, the motor may be any suitable type of motor, including electric, hydraulic, pneumatic, etc.

After flowing through the pump 66, the treatment chemicals flow into the primary lines 26 at inlets 70 to combine with the agricultural product flowing through the primary lines 26. In the present embodiment, each primary line 26 includes a mixing system 72 (e.g., annular grooves within each primary line, a spiral shaped insert, etc.) downstream from the inlets 70. The mixing system 72 improves the mixing of the agricultural product and the treatment chemicals. Further, a controller controls a motor to control the flow rate of the treatment chemicals alone (e.g., in on or off embodiments), or in combination with the valve 64.

FIG. 4 is a schematic diagram of an embodiment of a treatment system 25 that may be utilized with the air cart of FIG. 2. The treatment system 25 is configured to direct treatment chemicals from the treatment chemical supply 42 to the primary lines 26. In the present embodiment, the treatment system 25 includes a splitter 60, secondary treatment lines 62, a pump 66 driven by a motor 68, and clutches 76 disposed within the pump 66. The motor 68 drives the pump 66, which in turn drives the treatment chemicals to flow from the treatment chemical supply 42 to the primary lines 26. As the treatment chemicals travel toward the primary lines 26, the treatment chemicals pass through the primary treatment line 44, then through the splitter 60 and into the secondary treatment lines 62. Some embodiments may not include the splitter. In such embodiments, single lines extend from the treatment chemical supply 42 to the pump 66. In the present embodiment, the number of secondary treatment lines 62 corresponds to the number of primary lines 26. In some embodiments, each secondary treatment line may be fluidly coupled to more than one primary line. For example, one secondary treatment line may be fluidly coupled to 2, 3, 4, 5, or more primary lines. In other embodiments, each primary line may be fluidly coupled to more than one secondary treatment line. For example, one primary line may be fluidly coupled to 2, 3, 4, 5, or more secondary treatment lines.

Clutches 76 are disposed within the pump 66 along the path of each of the secondary treatment lines 62. The clutches 76 control the output of the pump 66, thereby controlling the flow rate of treatment chemicals through the respective secondary treatment line 62. The clutches 76 enable the pump 66 to selectively apply pressure to each of the secondary treatment lines 62. For example, the clutches 76 enable the pump 66 to apply pressure to a portion of the secondary treatment lines 62. Further, the clutches 76 may include any suitable type of clutch, including a friction clutch, a dog clutch, a cone clutch, etc. Each clutch 76 may be individually controlled (e.g., hydraulically, electrically, or manually) to control the flow of treatment chemicals through a corresponding secondary treatment line 62. For example, the controller 50 may control the clutches 76, or each clutch 76 may include a corresponding controller. The controller 50 may control the clutches 76 based at least in part on the product flow through respective primary lines, the rate of the meter roller, etc. Further, each clutch 76 may include two or more positions, with each position corresponding to a certain change in output of the pump 66.

In the present embodiment, the pump 66 is a single pump driven by a single motor 68, and the pump 66 is fluidly coupled to all of the secondary treatment lines 62. In some embodiments, multiple motors may drive the pump, such as 2, 3, 4, or more motors. Further, some embodiments may include multiple pumps 66. For example, each secondary treatment line may pass through multiple pumps. In some embodiments, multiple pumps may be utilized such that only a portion (e.g., 1, 2, 3, 4, or more) of the secondary treatment lines pass through each pump. Further, the pump may be any suitable type of pump, such as a peristaltic pump, gear pump, diaphragm pump, etc. Further, the motor may be any suitable type of motor, including electric, hydraulic, pneumatic, etc.

After flowing through the pump 66, the treatment chemicals flow into the primary lines 26 at inlets 70 to combine with the agricultural product flowing through the primary lines 26. In the present embodiment, each primary lines 26 includes a mixing system 72 (e.g., annular grooves within each primary line, a spiral shaped insert, etc.) downstream from the inlet 70. The mixing system 72 improves the mixing of the agricultural product and the treatment chemicals. Further, a controller controls a motor to control the flow rate of the treatment chemicals alone (e.g., in on or off embodiments), or in combination with the clutch 76.

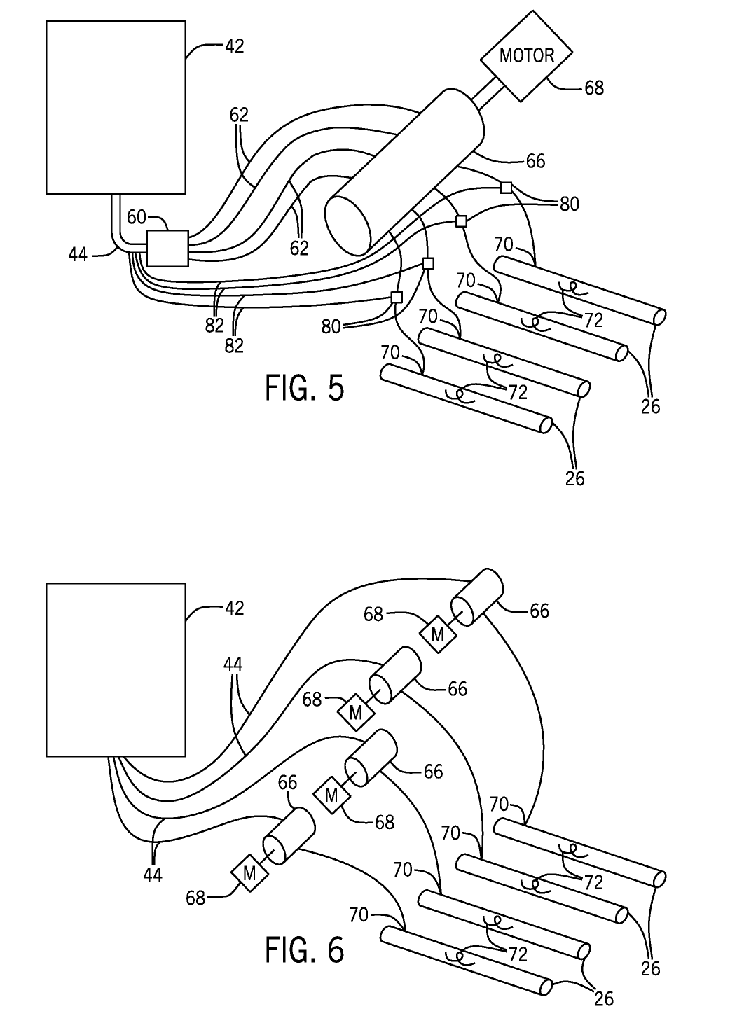

FIG. 5 is a schematic diagram of an embodiment of a treatment system 25 that may be utilized with the air cart of FIG. 2. The treatment system 25 is configured to direct treatment chemicals from the treatment chemical supply 42 to the primary lines 26. In the present embodiment, the treatment system 25 includes a splitter 60, secondary treatment lines 62, valves 80, a pump 66 driven by a motor 68, and diverter lines 82. The motor 68 drives the pump 66, which in turn drives the treatment chemicals to flow from the treatment chemical supply 42 to the primary lines 26. As the treatment chemicals travel toward the primary lines 26, the treatment chemicals pass through the primary treatment line 44, then through the splitter 60 and into the secondary treatment lines 62. Some embodiments may not include the splitter. In such embodiments, single lines extend from the treatment chemical supply 42 to the pump 66. In the present embodiment, the number of secondary treatment lines 62 corresponds the number of primary lines 26. In some embodiments, each secondary treatment line may be fluidly coupled to more than one primary line. For example, one secondary treatment line may be fluidly coupled to 2, 3, 4, 5, or more primary lines. In other embodiments, each primary line may be fluidly coupled to more than one secondary treatment line. For example, one primary line may be fluidly coupled to 2, 3, 4, 5, or more secondary treatment lines.

In the present embodiment, the pump 66 is a single pump driven by a single motor 68, and the pump 66 is fluidly coupled to all of the secondary treatment lines 62. In some embodiments, multiple motors may drive the pump, such as 2, 3, 4, or more motors. Further, some embodiments may include multiple pumps. For example, each secondary treatment line may pass through multiple pumps. In some embodiments, multiple pumps may be utilized such that only a portion (e.g., 1, 2, 3, 4, or more) of the secondary treatment lines pass through each pump. Further, the pump may be any suitable type of pump, such as a peristaltic pump, gear pump, diaphragm pump, etc. Further, the motor may be any suitable type of motor, including electric, hydraulic, pneumatic, etc.

Valves 80 are disposed along each of the secondary treatment lines 62 to control the flow of treatment chemicals through the secondary treatment lines 62. In some embodiments, at least one valve 80 may be fluidly coupled to more than one secondary treatment line, such as 2, 3, 4, 5, or more secondary treatment lines. The at least one valve 80 controls the flow rate through all of the secondary treatment lines 62 fluidly coupled to the at least one valve 80. Further, the valves 80 may include any suitable type of valve, such as a cut off valve, a diverter valve, a needle valve, etc. Each valve 80 may be individually controlled (e.g., hydraulically, electrically, or manually) to control the flow of treatment chemicals through the corresponding secondary treatment line 62. For example, the controller 50 may control the valves 80, or each valve 80 may include a corresponding controller. In the present embodiment, the valves 80 are disposed downstream from the pump 66. In some embodiments, the valves may be disposed upstream of the pump. Further, the valves 80 may divert treatment chemicals from the corresponding secondary treatment line 62 to the corresponding diverter line 82, which transports the treatment chemicals upstream to the primary treatment line 44, upstream of the pump 66. For example, if the valve 80 is fully closed, then all of the treatment chemicals are diverted, if the valve 80 is halfway closed, then half of the treatment chemicals are diverted, and if the valve 80 is fully open, none of the treatment chemicals are diverted. Generally, the portion of treatment chemicals that do not flow downstream flow through a corresponding diverter line 82. In some embodiments, the diverter lines may transport the treatment chemicals to other suitable locations upstream of the pump, such as the splitter 60, the secondary treatment lines 62, or the treatment chemical supply 42.

After flowing through the valves 80, the treatment chemicals flow into the primary lines 26 at inlets 70 to combine with the agricultural product flowing through the primary lines 26. In the present embodiment, each primary lines 26 includes a mixing system 72 (e.g., annular grooves within the primary line, a spiral shaped insert, etc.) downstream from the inlet 70. The mixing system 72 improves the mixing of the agricultural product. Further, a controller controls a motor to control the flow rate of the treatment chemicals alone (e.g., in on or off embodiments), or in combination with the valve 80.

FIG. 6 is a schematic diagram of an embodiment of a treatment system 25 that may be utilized with the air cart of FIG. 2. The treatment system 25 is configured to direct treatment chemicals from the treatment chemical supply 42 to the primary lines 26. In the present embodiment, the treatment system 25 includes a pump 66 and a corresponding motor for each primary treatment line 44. Each motor 68 drives the corresponding pump 66, which in turn drives the treatment chemicals to flow from the treatment chemical supply 42 to the respective primary lines 26. In the present embodiment, the number of primary treatment lines 44 corresponds to the number of primary lines 26. In some embodiments, each primary treatment line may be fluidly coupled to more than one primary line. For example, one primary treatment line may be fluidly coupled to 2, 3, 4, 5, or more primary lines (e.g., via a splitter and multiple secondary treatment lines).

In the present embodiment, each pump 66 is a single pump driven by a single motor 68. In some embodiments, multiple motors may drive each pump, such as 2, 3, 4, or more motors. Further, each primary treatment line may pass through multiple pumps. Further, each pump 66 may be any suitable type of pump, such as a peristaltic pump, a gear pump, a diaphragm pump, etc. Further, the motor may be any suitable type of motor, including electric, hydraulic, pneumatic, etc. Each motor 68 may be individually controlled (e.g., hydraulically, electrically, or manually) to control the flow of treatment chemicals through corresponding primary treatment lines 44. For example, the controller 50 may control the motors 68, or each motor 68 may include a corresponding controller. The controller may control the motors 68 to start or stop, or control the speed of the motors 68 based at least in part on the flow rate of product through the primary lines, speed of meter rollers, position in the field, etc.

After flowing through the pumps 66, the treatment chemicals flow into the primary lines 26 at inlets 70 to combine with the agricultural product flowing through the primary lines 26. In the present embodiment, each primary lines 26 includes a mixing system 72 (e.g., annular grooves within each primary line, a spiral shaped insert, etc.) downstream from the inlet 70. The mixing system 72 improves the mixing of the agricultural product.

While only certain features and embodiments of the disclosure have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, orientations, etc.)) without materially departing from the novel teachings and advantages of the subject matter recited in the claims. It is, therefore, to be understood that the appended claims are intended to cover all such modifications and changes as fall within the true spirit of the disclosure. Furthermore, in an effort to provide a concise description of the embodiments, all features of an actual implementation may not have been described (i.e., those unrelated to the presently contemplated best mode of carrying out the disclosure, or those unrelated to enabling the claimed disclosure). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A treatment system comprising:
a plurality of treatment lines configured to flow treatment chemicals from a treatment chemical supply to a plurality of distribution lines configured to transport agricultural product to row units of an implement;
at least one a pump fluidly coupled to the plurality of treatment lines, wherein the at least one pump is configured to drive the treatment chemicals to flow from the treatment chemical supply to the plurality of distribution lines through the plurality of treatment lines; and
a plurality of valves, wherein each of the plurality of valves is fluidly coupled to at least one of the plurality of treatment lines, and each of the plurality of valves is configured to control the flow of the treatment chemicals through the at least one of the plurality of treatment lines.

2. The treatment system of claim 1, wherein each of the plurality of valves is fluidly coupled to only one of the plurality of treatment lines.

3. The treatment system of claim 1, wherein the plurality of valves are positioned upstream of the at least one pump.

4. The treatment system of claim 1, comprising a splitter fluidly coupled to a distribution treatment line and the plurality of treatment lines, wherein the splitter is configured to direct the treatment chemicals from a single distribution treatment line into the plurality of treatment lines.

5. The treatment system of claim 1, wherein the plurality of valves are positioned downstream from the at least one pump.

6. The treatment system of claim 5, wherein the plurality of valves comprises diverter valves each configured to divert a portion of the treatment chemicals to an upstream position through a corresponding diverter line.

7. The treatment system of claim 1, comprising the plurality of distribution lines, wherein at least one of the plurality of distribution lines comprises a mixing system positioned downstream from an inlet configured to receive the treatment chemicals.

8. The treatment system of claim 1, comprising a controller communicatively coupled to the plurality of valves and a motor configured to drive the at least one pump, wherein the controller is configured to control the motor to control a flow rate of the treatment chemicals.

9. The treatment system of claim 8, wherein the controller controls the motor based at least in part on a flow rate of agricultural product through the plurality of distribution lines.

10. A treatment system comprising:
a plurality of treatment lines configured to flow treatment chemicals from a treatment chemical supply to a plurality of distribution lines configured to transport agricultural product to row units of an implement;
a plurality of pumps, wherein each of the plurality of pumps is fluidly coupled to at least one of the plurality of treatment lines, and each of the plurality of pumps is configured to drive the treatment chemicals from the treatment chemical supply to at least one respective distribution line of the plurality of distribution lines through the at least one of the plurality of treatment lines;
a plurality of motors, wherein each motor is configured to drive a respective pump of the plurality of pumps; and
a controller communicatively coupled to the plurality of motors, wherein the controller is configured to independently control the plurality of motors to control the flow of the treatment chemicals through the plurality of treatment lines.

11. The treatment system of claim 10, wherein the controller controls the plurality of motors based at least in part on a flow rate of agricultural product through the plurality of distribution lines

12. The treatment system of claim 10, comprising the plurality of distribution lines, wherein at least one of the plurality of distribution lines comprises a mixing system positioned downstream from an inlet configured to receive the treatment chemicals.

13. The treatment system of claim 10, comprising a primary treatment line configured to receive the treatment chemicals from the treatment chemical supply and flow the treatment chemicals into the plurality of treatment lines.

14. The treatment system of claim 13, comprising a splitter fluidly coupled to the primary treatment line and the plurality of treatment lines, wherein the splitter is configured to direct the treatment chemicals from the primary treatment line into the plurality of treatment lines.

15. The treatment system of claim 10, wherein the plurality of pumps comprises peristaltic pumps.

16. A treatment system comprising:
a plurality of treatment lines configured to flow treatment chemicals from a treatment chemical supply to a plurality of distribution lines configured to transport agricultural product to row units of an implement;
a plurality of pumps, wherein each of the plurality of pumps is fluidly coupled to at least one of the plurality of treatment lines, and each of the plurality of pumps is configured to drive the treatment chemicals from the treatment chemical supply to at least one respective distribution line of the plurality of distribution lines through the at least one of the plurality of treatment lines;
a plurality of clutches, wherein each of the plurality of clutches is coupled to a respective pump of the plurality of pumps, and each of the plurality of clutches is configured to control an output of the respective pump.

17. The treatment system of claim 16, wherein each of the plurality of clutches is disposed within the respective pump.

18. The treatment system of claim 16, comprising the plurality of distribution lines, wherein at least one of the plurality of distribution lines comprises a mixing system positioned downstream from an inlet configured to receive the treatment chemicals.

19. The treatment system of claim 16, comprising a primary treatment line configured to receive the treatment chemicals from the treatment chemical supply and flow the treatment chemicals into the plurality of treatment lines.

20. The treatment system of claim 19, comprising a splitter fluidly coupled to the primary treatment line and the plurality of treatment lines, wherein the splitter is configured to direct the treatment chemicals from the primary treatment line into the plurality of treatment lines.
